(19) United States
(12) Patent Application Publication
(10) Pub. No.: US 2024/0236114 A1
(43) Pub. Date: Jul. 11, 2024

(54) SYSTEM AND METHOD FOR VERIFYING A RESOURCE DISTRIBUTION DEVICE FROM A PLURALITY VIA SCANNING DYNAMIC DEVICE-SPECIFIC COMPUTER-READABLE INDICIA

(71) Applicant: BANK OF AMERICA CORPORATION, Charlotte, NC (US)

(72) Inventors: Joseph Benjamin Castinado, North Glenn, CO (US); Paul Martin Mattison, Sherrills Ford, NC (US)

(73) Assignee: BANK OF AMERICA CORPORATION, Charlotte, NC (US)

(21) Appl. No.: 18/093,557

(22) Filed: Jan. 5, 2023

(51) Int. Cl. H04L 9/40

(52) U.S. Cl. CPC H04L 63/123; H04L 63/083; H04L 63/107; H04L 63/108

(57) ABSTRACT

Systems, computer program products, and methods are described herein for verifying a resource distribution device from a plurality via scanning dynamic device-specific computer-readable indicia. The method includes receiving an executed action request specific to the resource distribution device. The executed action request may comprise a unique identifier associated with the resource distribution device. The method further includes verifying the resource distribution device based on at least the unique identifier. Verification may be further comprised of identifying a match between the unique identifier and one or more identifiers stored in a database. The one or more identifiers stored in the database may be associated with one or more resource distribution devices. The method further includes triggering the resource distribution device to execute the executed action request in response to verification of the resource distribution device.

### TECHNOLOGICAL FIELD

Example embodiments of the present disclosure relate to systems and method for verifying a resource distribution device from a plurality via scanning dynamic device-specific computer-readable indicia.

### BACKGROUND

Secure usage of resource distribution devices requires authentication credentials at the resource distribution device. Furthermore, verification of a resource distribution device is required to process interactions, particularly when among a group of resource distribution devices.

Applicant has identified a number of deficiencies and problems associated with verifying a resource distribution device from a plurality via scanning dynamic device-specific computer-readable indicia. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for verifying a resource distribution device from a plurality via scanning dynamic device-specific computer-readable indicia.

In an example embodiment, a system for verifying a resource distribution device from a plurality via scanning dynamic device-specific computer-readable indicia is provided. The system includes at least one non-transitory storage device and at least one processing device coupled to the at least one non-transitory storage device. The at least one processing device is configured to receive from a user input device, an executed action request specific to the resource distribution device. The executed action request may comprise a unique identifier associated with the resource distribution device. The at least one processing device is further configured to verify the resource distribution device based on at least the unique identifier. Verifying may further comprise identifying a match between the unique identifier and one or more unique identifiers stored in a database. One or more identifiers may be associated with one or more resource distribution devices. The at least one processing device may be further configured to trigger the resource distribution device to execute the executed action request

In various embodiments, the triggering of the resource distribution device to execute the executed action request may be further comprised of determining a location information associated with the user input device. The embodiment may further be comprised of determining a location information associated with the resource distribution device. The embodiment may further be comprised of determining whether the location information associated with the user input device and the location information associated with the resource distribution device are within a predetermined geographical radius of each other. The embodiment may further be comprised of triggering the resource distribution device to execute the executed action request in an instance where the location information associated with the user input device and the location information associated with the resource distribution device are within the predetermined geographical radius of each other.

In various embodiments, triggering of the resource distribution device to execute the executed action request may be further comprised of denying the executed action request in an instance where the location information associated with the user input device and the location information associated with the resource distribution device are not within the predetermined geographical radius of each other. The embodiment may further be comprised of transmitting a notification to the user input device in response to denying the executed action request. The notification may comprise an indication that the location information associated with the resource distribution device are outside of a predetermined geographical radius of each other.

In various embodiments, receiving the executed action request from a specific resource distribution device, the system may be further configured to determine a time associated with the reception of the executed action request. The embodiment may further be comprised of determining whether a difference between the time associated with the reception of the executed action request and the time associated with the verification of the resource distribution device is within a predetermined time limit. The embodiment may further be comprised of triggering the executed action request in an instance where the difference between the time associated with the reception of the executed action request and the time associated with the verification of the resource distribution device is within a predetermined time limit.

In various embodiments, the unique identifier is associated with a computer-generated readable indicia captured by the user input device using an image capturing component associated therewith.

In various embodiments, the unique identifier obtained through the computer-generated readable indicia is compared and/or matched to unique identifiers stored in the database to verify the resource distribution device.

In various embodiments, the execution of the executed action request on the resource distribution device is enabled via entry of authentication credentials on the user input device.

In various embodiments, the executed action request on the resource distribution device is enabled via entry of authentication credentials on the user input device.

In various embodiments, the executed action is a deposit or withdrawal of resources from the resource distribution device.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for systems and method for verifying a resource distribution device from a plurality via scanning dynamic device-specific computer-readable indicia in accordance with an embodiment of the disclosure;

FIG. 2 illustrates a process flow for verifying a resource distribution device from a plurality via scanning dynamic device-specific computer-readable indicia, in accordance with an embodiment of the disclosure;

FIG. 3 illustrates verification and use of a resource distribution device in accordance with various embodiments of the present disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like.

As used herein, a “resource transfer,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

The present disclosure provides a system for verifying a resource distribution device among a plurality via scanning dynamic device-specific computer-readable indicia. Resource distribution devices allow for the automation of otherwise manual actions, such as currency retrieval and/or deposits. In order to securely process these executed actions, authentication credentials have been used to verify the incoming request and the resource distribution device. Therefore, entities may institute verification processes that reduce the number of steps to verify the incoming request and resource distribution device to trigger the physical executed action to occur.

The process of a user manually entering authentication credentials on a resource distribution device can be tedious and time consuming. A user entering authentication credentials may cause delays, restricting the number of users who may access the resource distribution device. Furthermore, depending on the location of the resource distribution device, entering authentication credentials in a public setting can also cause security concerns. This may include unauthorized password use by bystanders or related malicious activity.

Various embodiments of the system to verify a resource distribution device among a plurality using dynamic device-specific computer-readable indicia can reduce the time and resources spent on resolving issues that occur by entering authentication credentials into a resource distribution device. As such, resource distribution devices may accommodate a greater number of users within the same time frame. Furthermore, an individual user may decrease the amount of time used to obtain resources as well as avoid entering potentially sensitive information into the resource distribution device. A user may enter authentication credentials within a device independent of the resource distribution device, formulate an executed action request, then scan the indicia displayed on the resource distribution device. The indicia may contain a unique identifier, which may be used to verify the resource distribution device, and thus trigger the executed action request to be performed by the resource distribution device.

Accordingly, the present disclosure provides a system for providing verification of a resource distribution from a plurality using dynamic device-specific computer-readable indicia. Resource distribution devices utilize authentication credentials to perform executed action requests. If authentication credentials are entered into an independent device capable of scanning the device-specific computer-readable indicia, an executed action can be performed by the resource distribution device. Verification of the resource distribution device is accomplished through the scanning of the indicia displayed on the resource distribution device. The indicia contain a unique identifier that verifies the resource distribution device. The indicia also enable a user to select the resource distribution device amongst a plurality without entering authentication credentials into the resource distribution device. Reception of the executed action request and the unique identifier contained within the indicia may allow for verification of the executed action request. Upon verification, the resource distribution device is triggered to perform the executed action. The indicia may be changed on predetermined periodic routine.

What is more, the present disclosure provides a technical solution to a technical problem. As described herein, the technical problem includes the use of a resource distribution device securely wherein authentication credentials are not entered into the resource distribution device. The technical solution presented herein allows for verification of a resource distribution device through device-specific computer readable indicia enabling the use of the resource distribution device through the entry of authentication credentials outside of the resource distribution device. In particular, verification through device-specific computer readable indicia is an improvement over existing solutions to the manual entry of authentication credentials on a resource distribution device.

With fewer steps to access a resource distribution device, the amount of computing resources, such as processing resources, storage resources, network resources, and/or the like, that are being used are reduced. Material, power, and time may be saved as a resource distribution device may be verified despite authentication credentials being entered through an independent device. Additionally, manual input and waste may be removed from the implementation of the solution, thus improving speed and efficiency of the process and conserving computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

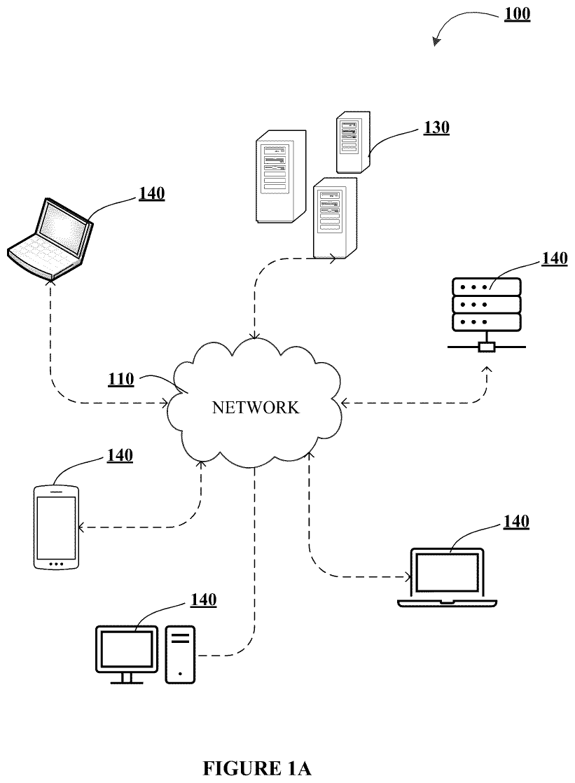

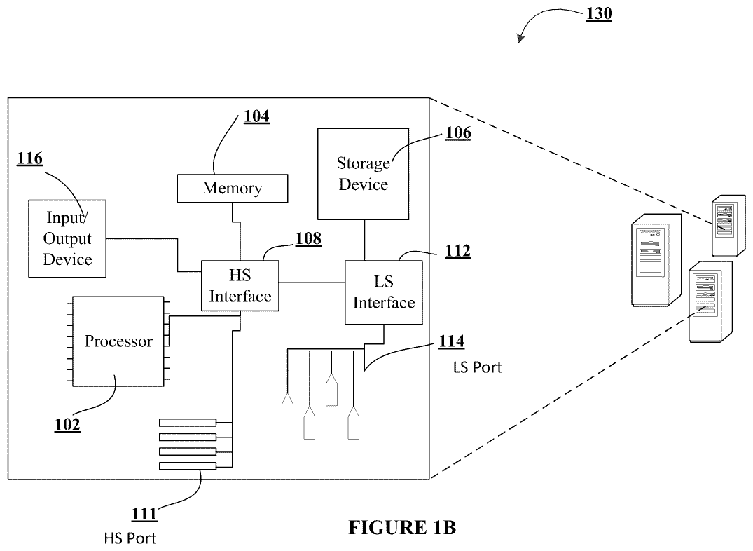

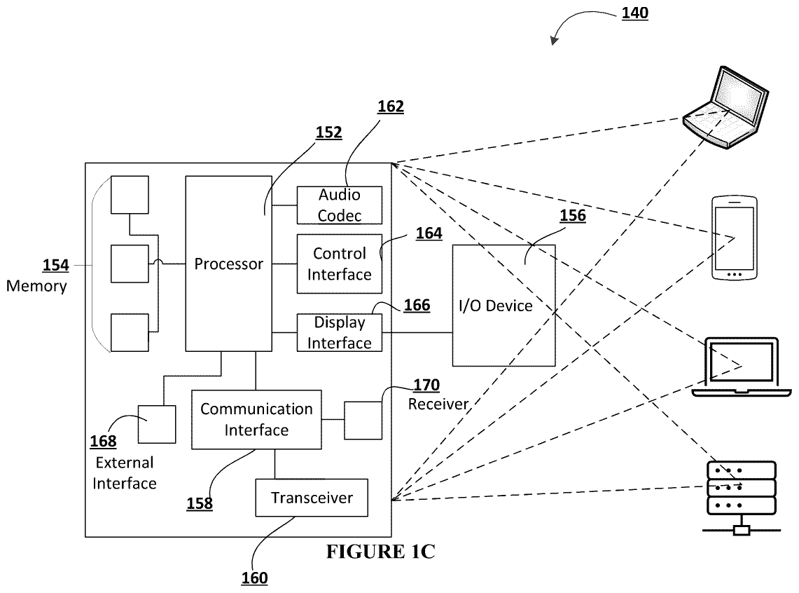

FIGS. 1A-1C illustrate technical components of an exemplary distributed computing environment for verifying a resource distribution device from a plurality via scanning dynamic device-specific computer-readable indicia 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as resource distribution devices—devices capable of distributing resources, resource recycling devices—devices capable of automating the process of accepting and dispensing resources, point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

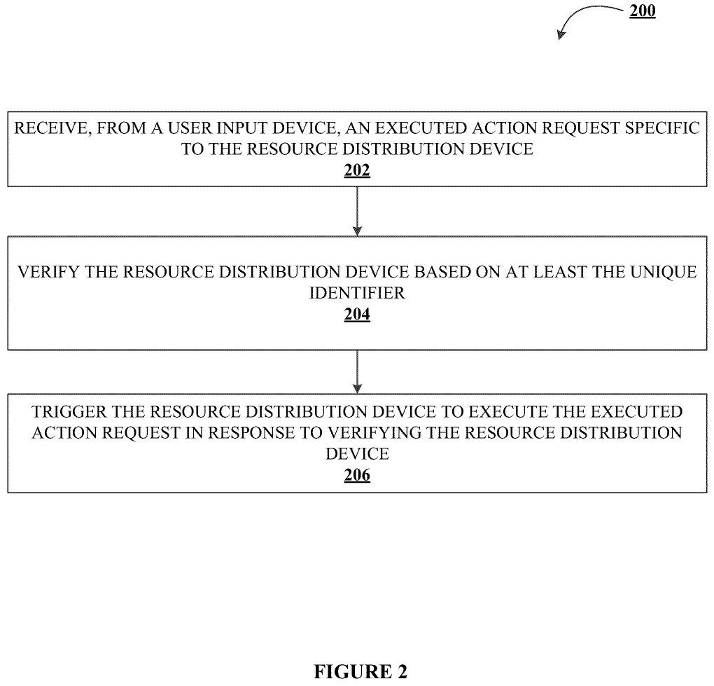

FIG. 2 is a flow chart 200 that illustrates an example of a method for providing verification of a resource distribution device via scanning dynamic device-specific computer-readable indicia. The method may be carried out by various components of the distributed computing environment 100 discussed herein (e.g., the systems 130, one or more end-point devices 140, etc.). An example system may include at least one non-transitory storage device and at least one processing device coupled to the at least one non-transitory storage device. In such an embodiment, the at least one processing device is configured to carry out the method discussed herein. While the method discussed herein references a resource distribution device, various other automated processing devices may also use the method discussed herein.

Referring now to Block 202 of FIG. 2, the method includes receiving an executed action request specific to the resource distribution device from a user input device. In various embodiments, the resource distribution device may be among a group of at least one resource distribution devices located in a predetermined area. The group of at least one resource distribution devices may comprise of multiple devices of the same make and model capable of resource distribution. In another embodiment the plurality of resource distribution devices may also include multiple devices of differing makes and models, as well as differing capabilities and functions that may be capable of distributing resources as described herein. The plurality of resource distribution devices may further include a mixture of multiple resource distribution devices of the same make and model, as well as resource distribution devices of differing capabilities and functions.

Further referring to Block 202 of FIG. 2, the received executed action request may contain a unique identifier with the accompanying request. The unique identifier may be obtained through the scanning of the device-specific computer-readable indicia that may be accessible on the resource distribution device (e.g., a main interface of the resource distribution device, or a physical embodiment of the indicia displayed on the resource distribution device that may be scanned by the user input device). In various embodiments, the indicia may be scanned by an end-point device 140 that matches the device-specific and computer-readable indicia.

In various embodiments, the unique identifier obtained from the indicia may contain an attribute specifically customized to the resource distribution device. The unique identifier may further contain information recognizing the resource distribution device such as a unit number, model, passcode, password, and/or a form of an identifier that can be obtained through scanning of the device-specific computer-readable indicia. The unique identifier may further be able to be mapped to the resource distribution device as the unique identifier may be compared to an existing table, list, or records of unique identifiers. The information obtained upon the scanning of the indicia may include a category of usage relating to the resource distribution device. The category of usage may further include information regarding the resource distribution device such as the location, the model, the capabilities, and/or resources available to be distributed within the resource distribution device.

The indicia may further be displayed in an accessible area of the resource distribution device in which the indicia may be scanned using the user input device (or any end-point device having the capability to scan such indicia). In various embodiments, indicia may refer to signs, indications, or distinguishing marks representative of a specific resource distribution device. The indicia may refer to a quick response code (QR code), a barcode, or a machine-readable code capable of being scanned by a computer-readable device (such as a mobile device comprising a camera). Indicia embodied by a QR code may refer to square shaped matrices of dark or light pixels used to encode and quickly retrieve data using computer devices. The data encoded in the QR code may refer to attributes or categories of usage associated with the resource distribution device. The QR code may be displayed in variants such as a model 1 variant, micro QR code, secure QR code, frame QR code, High capacity colored 2-dimensional (HCC2D) code, or the like. Additionally, the QR code may have a configurable version number and/or character modes (numeric, alphanumeric, binary/byte, kanji/kana). Indicia embodied by a barcode may refer to a machine-readable code in the form of numbers and a pattern of parallel lines of varying widths, printed or displayed on the resource distribution device and identifying the resource distribution device and the attributes or categories of usage associated with the resource distribution device. The data encoded in the barcode may similarly refer to attributes or categories of usage associated with the resource distribution device as a QR code explained previously. The barcode may be displayed in embodiments including linear or 2D matrix barcodes. The indicia may be device-specific, computer-readable, and contain a unique identifier.

With further reference to Block 202 of FIG. 2, in various embodiments, the unique identifier is associated with a computer-generated readable indicia captured by the user input device using an image capturing component associated therewith. In this embodiment, the user input device may be used to capture the unique identifier within the computer-generated readable indicia displayed on the resource distribution device. For example, the user input device may be a mobile phone capable of scanning the indicia displayed on the resource distribution device. The mobile device may then be used to enter authentication credentials on the mobile device to access an account capable of requesting executable actions through the resource distribution device. Furthermore, the mobile device may send the executable action request with the accompanying unique identifier.

In various embodiments, the indicia displayed on the resource distribution device are regenerated periodically. The indicia displayed may be altered on a predetermined, periodic schedule to promote secure executed action requests. For example, a QR code displayed on the resource distribution device may be altered on an hourly basis. This alteration may change the QR code but maintain the original functions the indicia were meant to perform. The periodic regeneration frequency may also be configurable based on the predetermined settings of the resource distribution device.

In further reference to Block 202 of FIG. 2, the executed action request may comprise a request for the resource distribution device associated with the unique identifier to perform an executed action. The executed action in the executed action request may include a deposit, withdrawal, payment using resources utilizing the resource distribution device, or any other resource transfer within the capability of the resource distribution device.

With continued reference to Block 202, the user of the user input device may be required to authenticate themselves prior to being able to transmit the executed action request. In some embodiments, the authentication credentials entered as part of the authentication of the user may link the user of the device to a predetermined entity and a predetermined account within said entity. Here, the authentication credentials may be entered on the user input device used to scan the indicia as opposed to entering authentication credentials through the resource distribution device. In this embodiment, entry of authentication credentials may be confined to the end-point device 140 used to scan the device-specific computer-readable indicia. Authentication credentials may be entered on the end-point device 140 and may be entered through the usage of a software, app, or means of accessing an account that can be accessed and/or manipulated using the resource distribution device.

Referring now to Block 204 of FIG. 2, the method includes verifying the resource distribution device by the reception of at least the unique identifier. The unique identifier obtained through the scanned device-specific computer-readable indicia may provide identifying information regarding the resource distribution device as described above. The information received may verify the resource distribution device which in turn may enable the specific resource distribution device to perform the executed action request. Verification is further provided, in that the selected resource distribution device is the device in which the executed action may be performed, as the scanned indicia associated with the resource distribution device may have been used to select the specific resource distribution device. An executed action request containing the unique identifier obtained from the device-specific computer-readable indicia may therefore verify the resource distribution device and enable the resource distribution device to be triggered to perform the executed action associated with the executed action request. The unique identifier may show the location of the resource distribution device through location data obtained through the unique identifier. The unique identifier may further contain a unique link attributable to the resource distribution device verifying that a user has scanned indicia attributable to the resource distribution device. The indicia may further contain features, identifiers, or information which may be used to verify the resource distribution device and the executed action request.

With continued reference to Block 204 of FIG. 2, in various embodiments, the unique identifier obtained through the computer-generated readable indicia is compared and/or matched to stored unique identifiers to verify the resource distribution device. In this embodiment, a mapping function may be used to map known unique identifiers to the unique identifier received in the executed action request. Verification of the resource distribution device may be achieved if the unique identifier attributable to the resource distribution device matches the unique identifier previously known to be attributed to the resource distribution device.

With continued reference to Block 204 of FIG. 2, in some embodiments, the unique identifier may contain a secured link with information which may be used to verify the resource distribution device, a passcode or password that grants access to information which may be used to verify the resource distribution device, or a means of gathering data to form a category of usage from the resource distribution device and/or the device used to scan the indicia. In some other embodiments, the unique identifier may include a device type associated with the resource distribution device. Determination of the device type may include information regarding the resource distribution device such as the make, model, capabilities, functions, and security procedures of the resource distribution device.

Referring now to Block 206, the method includes triggering an executed action obtained through the executed action request to be performed by the resource distribution device associated with the unique identifier in response to verifying the resource distribution device. In example embodiments, the performance of the executed action may include dispensing resources, accepting resources, or the exchanging of resources. The resource distribution device may be triggered to perform the executed action after receiving and verifying the executed action request and the unique identifier obtained through scanning the indicia associated with the resource distribution device.

Referring again to Block 206, in various embodiments, the triggering of the resource distribution device to execute the executed action, the system may be configured to determine a geographic or positional location associated with the user input device. The procurement of the user input device location may be accomplished through information received through the executed action request. Using the location information associated with the user input device, the geographic distance between the user input device and the resource distribution device may be calculated. If the calculated geographic distance between the resource distribution device and the user input device exceeds a predetermined distance or radius, the resource distribution device may be triggered to perform the executed action. For example, settings may be configured to execute the executed action if the calculated geographic distance between the user input device and the resource distribution device are within a distance of 10 meters.

In a further embodiment, if the calculated geographic distance between the user input device and the resource distribution device are not within the predetermined distance, the executed action request may be denied/and or transmit a notification to the user input device. The denial of the executed action request may occur due to configured settings determining the distance between the user input device when sending the executed action request and the resource distribution device. A denial of the executed action request may result in a notification of denial, or the executed action request being sent for further processing. The geographic distance may further be used to determine possible malicious activity. For example, if the calculated geographic distance exceeds a predetermined distance limitation of 1 mile, the executed action request may be denied and/or a notification may be sent to the user input device. The transmitted notification to the user input device may be comprised of a text message, email, phone call, or transmitted to the authentication credentials associated with the executed action request.

Referring again to Block 206, in various embodiments, the time in which the executed action request is received may be determined. The determined time in which the executed action request was received may further be used to calculate the time passed between when the executed action request was received, and when the executed action from the executed action request may be triggered to occur on the resource distribution device. If the time passed between reception of the executed action request and the triggering of the resource distribution device exceeds a predetermined length of time, a denial of the executed action request and/or a notification may be transmitted to the user input device or end-point device regarding the executed action request may be sent. This may include denial of the executed action request, reentry of an executed action request to proceed, or reentry of authentication credentials on the end point device used to scan the indicia and submit the executed action request.

In various embodiments, the executed action is a category of usage of the resource distribution device, wherein the category of usage may be embodied as a deposit, withdrawal, or other form of resource exchange. The category of executed action may include one type of action (e.g., one withdrawal, or one deposit) or a combination of various actions (e.g., a cash deposit and a withdrawal).

The executed action of withdrawing resources may refer to the resource distribution device distributing resources to a user. The distribution of said resources may be reflected within an account associated with the provided authentication credentials. The resources withdrawn may include a physical exchange of resources. The resource distribution device may be triggered to dispense and/or receive the physical resources through reception of the executed action request and the accompanying unique identifier used to verify the resource distribution device.

The executed action of depositing resources may refer to the resource distribution device accepting resources from a user and reflecting the resource exchange within an account associated with the authentication credentials provided. The resources deposited may include a physical exchange of resources such as cash, coins, or checks. The resource distribution device may be triggered to perform the functions and protocols associated with acceptance of these resources based off the executed action request and accompanying identifier verifying the request and the resource distribution device.

The executed action may further refer to multiple actions embodied in a singular request. Multiple actions within the executed action may refer to a group of at least one transfer or exchange of resources. For example, an executed action request may contain instructions to withdraw resources from the resource distribution device while also paying a bill using the resource distribution device.

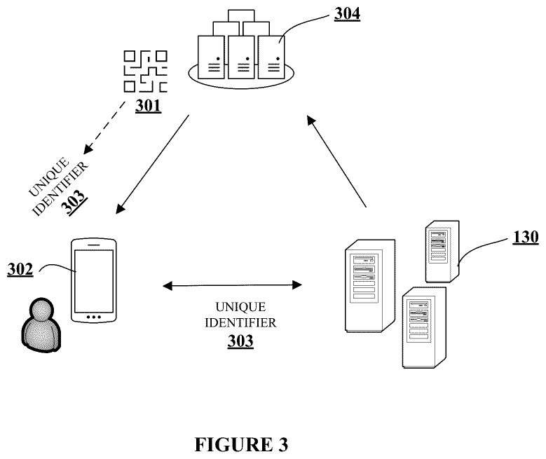

FIG. 3 illustrates an example verification and use of a resource distribution device. Various systems and components discussed in reference to FIG. 3 may be carried out by the various components of the distributed computing environment 100 discussed herein (e.g., the systems 130, one or more end-point devices 140, etc.).

As shown in FIG. 3, the resource distribution device 304 may display indicia 301 (such as for example a QR code) which may be scanned by the user input device 302. The indicia 301 for a resource distribution device 304 may be unique to the resource distribution device 304 from which it was scanned. The indicia 301 may be captured using the user input device 302 through an image capturing component. Scanning of the indicia 301 may determine the resource distribution device 304 in which the executed action request may occur.

The executed action request may be formed by the user through the entrance of authentication credentials on the user input device 302 and may include selection of an executed action. The entrance of authentication credentials on the user input device 302 may enable the formation of an executed action through an account enabled to interact with the resource distribution device 304. The account may be linked to an entity that manages executable actions that may occur on a resource distribution device 304. As part of forming the executed action request, the user may identify the resource distribution device 304 preferred by the user to execute the executed action request by scanning the indicia 301 associated with the resource distribution device 304. The indicia scanned by the user input device 302 may contain a unique identifier 303. The unique identifier 303 may be used to verify the resource distribution device 304 associated with the executed action request. The verification of the resource distribution device 304 may occur through comparison of the unique identifier 303 to unique identifiers stored in the system 130. Unique identifiers stored in the system 130 may be mapped or compared to the unique identifier 303 accompanying the executed action request.

Upon successful verification of the resource distribution device 304, the system 130 may trigger the resource distribution device 304 to perform the executed action associated with the executed action request. The resource distribution device 304 may then perform the executed action within the executed action request.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for verifying a resource distribution device from a plurality via scanning dynamic device-specific computer-readable indicia comprising:
a processing device;
a non-transitory storage device containing instructions when executed by the processing device, causes the processing device to:
receive, from a user input device, an executed action request specific to the resource distribution device, wherein the executed action request comprises a unique identifier associated with the resource distribution device;
verify the resource distribution device based on at least the unique identifier, wherein verifying further comprises identifying a match between the unique identifier and one or more identifiers stored in a database, wherein the one or more identifiers are associated with one or more resource distribution devices; and
trigger the resource distribution device to execute the executed action request in response to verifying the resource distribution device.

2. The system of claim 1, wherein, in triggering the resource distribution device to execute the executed action request, the system is further configured to:
determine a location information associated with the user input device;
determine a location information associated with the resource distribution device;
determine whether the location information associated with the user input device and the location information associated with the resource distribution device are within a predetermined geographical radius of each other; and
trigger the resource distribution device to execute the executed action request in an instance where the location information associated with the user input device and the location information associated with the resource distribution device are within the predetermined geographical radius of each other.

3. The system of claim 2, wherein, in triggering the resource distribution device to execute the executed action request, the system is further configured to:
deny the executed action request in an instance where the location information associated with the user input device and the location information associated with the resource distribution device are not within the predetermined geographical radius of each other; and
transmit a notification to the user input device in response to denying the executed action request, wherein the notification comprises an indication that the location information associated with the user input device and location information associated with the resource distribution device are outside of a predetermined geographical radius of each other.

4. The system of claim 1, wherein, in receiving the executed action request from a specific resource distribution device, the system is further configured to:
determine a time associated with the reception of the executed action request;
determine a time associated with the verification of the resource distribution device;
determine whether a difference between the time associated with the reception of the executed action request and the time associated with the verification of the resource distribution device is within a predetermined time limit; and
trigger the executed action request in an instance where the difference between the time associated with the reception of the executed action request and the time associated with the verification of the resource distribution device is within a predetermined time limit.

5. The system of claim 1, wherein the unique identifier is associated with a computer-generated readable indicia captured by the user input device using an image capturing component associated therewith.

6. The system of claim 5, wherein the unique identifier obtained through the computer-generated readable indicia is compared and/or matched to identifiers stored in the database to verify the resource distribution device.

7. The system of claim 1, wherein execution of the executed action request on the resource distribution device is enabled via entry of authentication credentials on the user input device.

8. The system of claim 1, wherein the executed action is a deposit or withdrawal of resources from the resource distribution device.

9. A computer program product for verifying a resource distribution device from a plurality via scanning dynamic device-specific computer-readable indicia, the computer program product comprising at least one non-transitory computer-readable medium having computer-readable program code portions embodied therein, the computer-readable program code portions comprising:
an executable portion configured to receive, from a user input device, an executed action request specific to the resource distribution device, wherein the executed action request comprises a unique identifier associated with the resource distribution device;
an executable portion configured to verify the resource distribution device based on at least the unique identifier, wherein verifying further comprises identifying a match between the unique identifier and one or more identifiers stored in a database, wherein the one or more identifiers are associated with one or more resource distribution devices; and
an executable portion configured to trigger the resource distribution device to execute the executed action request in response to verifying the resource distribution device.

10. The computer program product of claim 9, wherein in triggering the resource distribution device to execute the executed action request, the computer program product is further configured to:
determine a location information associated with the user input device;
determine a location information associated with the resource distribution device
determine whether the location information associated with the user input device and the location information associated with the resource distribution device are within a predetermined geographical radius of each other; and
trigger the resource distribution device to execute the executed action request in an instance where the location information associated with the user input device and the location information associated with the resource distribution device are within the predetermined geographical radius of each other.

11. The computer program product of claim 10, wherein in triggering the resource distribution device to execute the executed action request, the computer program product is further configured to:
deny the executed action request in an instance where the location information associated with the user input device and the location information associated with the resource distribution device are not within the predetermined geographical radius of each other; and
transmit a notification to the user input device in response to denying the executed action request, wherein the notification comprises and indication that the location information associated with the user input device and location information associated with the resource distribution device are outside of a predetermined geographical radius of each other.

12. The computer program product of claim 9, wherein, in receiving the executed action request from a specific resource distribution device, the computer program product is further configured to:
determine a time associated with the reception of the executed action request;
determine whether a difference between the time associated with the reception of the executed action request and the time associated with the verification of the resource distribution device is within a predetermined time limit; and
trigger the executed action request in an instance where the difference between the time associated with the reception of the executed action request and the time associated with the verification of the resource distribution device is within a predetermined time limit.

13. The computer program product of claim 9, wherein the unique identifier is associated with a computer-generated readable indicia captured by the user input device using an image capturing component associated therewith.

14. The computer program product of claim 13, wherein the unique identifier obtained through the computer-generated readable indicia is compared and/or matched to identifiers stored in the database to verify the resource distribution device.

15. The computer program product of claim 9, wherein execution of the executed action request on the resource distribution device is enabled via entry of authentication credentials on the user input device.

16. A computer-implemented method for verifying a resource distribution device from a plurality via scanning dynamic device-specific computer-readable indicia, the method comprising:
receiving, from a user input device, an executed action request specific to the resource distribution device, wherein the executed action request comprises a unique identifier associated with the resource distribution device;
verifying the resource distribution device based on at least the unique identifier, wherein verifying further comprises identifying a match between the unique identifier and one or more identifiers stored in a database, wherein the one or more identifiers are associated with one or more resource distribution devices; and
triggering the resource distribution device to execute the executed action request in response to verifying the resource distribution device.

17. The method of claim 16, wherein, in triggering the resource distribution device to execute the executed action request, the method further comprises:
determining location information associated with the user input device;
determining location information associated with the resource distribution device;
determining whether the location information associated with the user input device and the location information associated with the resource distribution device are within a predetermined geographical radius of each other; and
triggering the resource distribution device to execute the executed action request in an instance where the location information associated with the user input device and the location information associated with the resource distribution device are within the predetermined geographical radius of each other.

18. The method of claim 17, wherein, in triggering the resource distribution device to execute the executed action request, the method further comprises:
denying the executed action request in an instance where the location information associated with the user input device and the location information associated with the resource distribution device are not within the predetermined geographical radius of each other; and
transmitting a notification to the user input device in response to denying the executed action request, wherein the notification comprises an indication that the location information associated with the user input device and location information associated with the resource distribution device are outside of a predetermined geographical radius of each other.

19. The method of claim 16, wherein, in receiving the executed action request from a specific resource distribution device, the method further comprises:
determining a time associated with the reception of the executed action request;
determining whether a difference between the time associated with the reception of the executed action request and time associated with the verification of the resource distribution device is within a predetermined time limit; and
triggering the executed action request in an instance where the difference between the time associated with the reception of the executed action request and the time associated with the verification of the resource distribution device is within a predetermined time limit.

20. The method of claim 16, wherein the unique identifier is associated with a computer-generated readable indicia captured by the user input device using an image capturing component associated therewith.
